(19) United States
(12) Patent Application Publication
(10) Pub. No.: US 2017/0004410 A1
(43) Pub. Date: Jan. 5, 2017

(54) Standardized process to quantify the value of research manuscripts

(71) Applicant: CHRISTOPHER WILLIAM PARAN, ANN ARBOR, MI (US)

(72) Inventor: CHRISTOPHER WILLIAM PARAN, ANN ARBOR, MI (US)

(21) Appl. No.: 14/791,252

(22) Filed: Jul. 3, 2015

(51) Int. Cl. G06N 7/00; G06F 17/30

(52) U.S. Cl. CPC G06N 7/005; G06F 17/30011; G06K 9/18

(57) ABSTRACT

This invention is for a standardized process to quantify the value of research manuscripts. It consists of four steps: 1) the overall argument structure of the paper is encoded into a language of symbolic logic, 2) each logic statement is assigned a probability value based on information provided in the manuscript, 3) the methodologies used in the research manuscript are examined, and 4) the research manuscript is inspected for any duplicate text or images. Each step assigns or modifies probability values to some or all of the logical statements in the overall logical argument, and the result is a single probability value indicating the value of the manuscript. This process may be performed by humans or by a computer capable of some or all of the following functions: text and/or image recognition; and the use of electronic databases containing information regarding symbolic logic, statistics and research methodologies.

### CROSS REFERENCE TO RELATED APPLICATIONS

The present utility patent application does not build upon utility patents previously acquired by myself. However, some patents have been published which are relevant to concepts mentioned in the present application, including:

U.S. Pat. No. 4,860,376 A—Character recognition system for optical character reader

U.S. Pat. No. 4,251,799 A—Optical character recognition using baseline information

U.S. Pat. No. 5,150,425 A—Character recognition method using correlation search

U.S. Pat. No. 6,763,148 B1—Image recognition methods

U.S. Pat. No. 8,391,615 B2—Image recognition algorithm, method of identifying a target image using same, and method of selecting data for transmission to a portable electronic device

U.S. Pat. No. 8,897,577 B2—Image recognition device and method of recognizing image thereof

US 20010056422 A1—Database access system

U.S. Pat. No. 6,654,731 B1—Automated integration of terminological information into a knowledge base

U.S. Pat. No. 6,038,560 A—Concept knowledge base search and retrieval system

U.S. Pat. No. 5,226,111 A—Organization of theory based systems

U.S. Pat. No. 5,655,116 A—Apparatus and methods for retrieving information

U.S. Pat. No. 4,930,071 A—Method for integrating a knowledge-based system with an arbitrary database system

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The most important thing in science is the accuracy, or truthfulness, of the research data, which are collected through various research activities and often published in the form of a research manuscript. Unfortunately, there are problems with existing research organizational systems, specifically with respect to a lack of data reproducibility and validity. Different solutions have been proposed. These solutions tend to suggest one or more of the following: better future use of statistics for study design, power analysis, and statistical testing; allowing open access to raw data: repeating studies in another laboratory; or statistical meta analysis of multiple research papers. These are good ideas, but they do not allow one to determine whether or not a research manuscript is true based on the manuscript itself. Thus, having a research manuscript truth analysis system would be enormously beneficial because it would help scientists to learn only true things about reality and to ignore false things. This would save a lot of time and money for individuals, governments, and corporations, as these resources would not be wasted on false research directions. Also, it would speed science and technological development by allocating more resources to fruitful research directions. Therefore, a standardized process to quantify the value of research manuscripts is desired, and this process may be carried out by a human and/or a computer. The use of a computer that can perform said analysis would be an important step for humans in that a computer would be able to perform the analysis much faster than a human, With enough computing power it would be theoretically possible to analyze every research manuscript ever published, significantly increasing the efficiency of human research efforts.

### BRIEF SUMMARY OF THE INVENTION

The invention is for a standardized process to quantify the value of research manuscripts. The process requires reading the research manuscript text and images to obtain information about the manuscript's overall argument structure, data, methodologies, and duplicated text or images. This information is used to calculate a probability score for the manuscript indicating how likely it is that the manuscript is true. This process may be performed by a human and/or a computer.

### BRIEF DESCRIPTION OF THE SEVERAL VIEWS OF THE DRAWING

FIG. 1. Diagram of the standardized process to quantify the value of research manuscripts.

FIG. 2. Diagram of subroutines used by a computer entity to perform the manuscript analysis process.

### DETAILED DESCRIPTION OF THE INVENTION

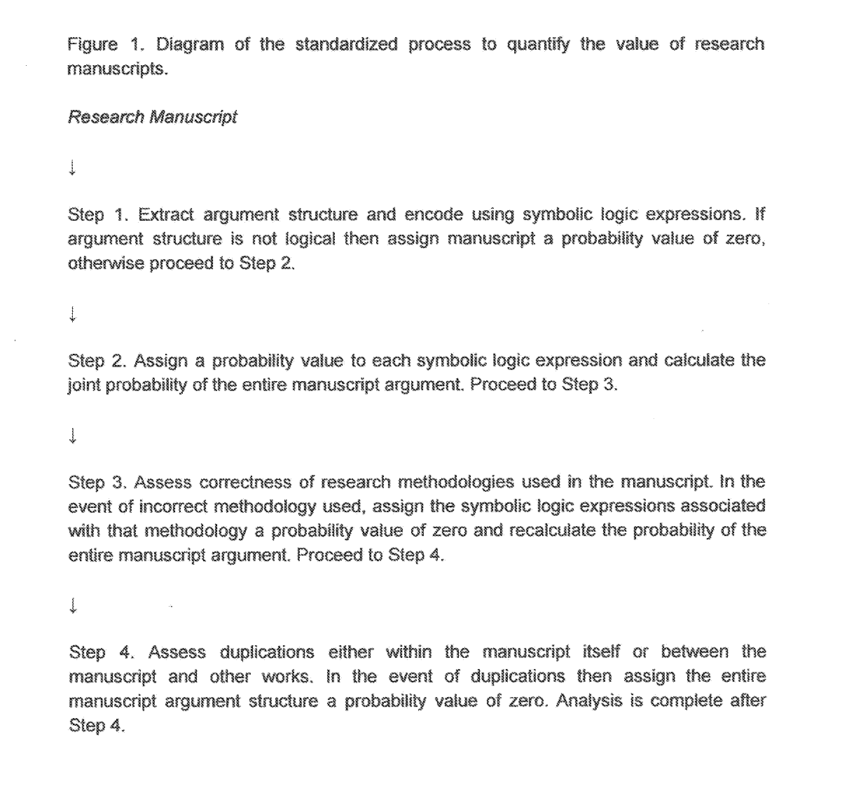

The invention is for a standardized process to quantify the value of published research manuscripts. The process consists of 4 distinct steps, depicted in FIG. 1.

(Step 1) First, the overall argument structure of the paper is encoded into a language of symbolic logic, with one or more statements for each experiment in the manuscript. Typically, a research manuscript contains experiments that can be encoded into two types of logic statements: either a simple proposition statement, or an if-then statement. A simple proposition statement would be made in the case of an experiment that simply collects data about a particular system, such as measuring blood pressure; e.g., if A=blood pressure is 120 mmHg, then the propositional statement is simply “A.” An if-then statement would be the result of an experiment that collects data about a system upon perturbation, such as measuring blood pressure after administering a drug; e.g., if B=drug X is administered, and A=blood pressure is 140 mmHg, then an if-then statement could be written “if B, then A.” Note that in some cases it may be appropriate to encode a simple proposition as an if-then statement, with the implication arising from a variable not directly referenced in the manuscript. For example, the time of day or body temperature may influence blood pressure and may need to be accounted for when constructing the overall argument structure for the manuscript. In some cases, a single experiment in a manuscript may need to be encoded into more than one logical statement. The process of translating the experimental results into one or more symbolic logic expressions is then repeated for all of the experiments in the manuscript to produce a complete logical argument for the entire manuscript. For example, a manuscript with three experiments encoded as if-then statements may be chained together in the single statement “(if A, then B) AND (if B, then C) AND (if C, then D)”; so in this example, the purpose of the manuscript would therefore be to make the claim “if A, then D.” To evaluate whether the overall argument structure in the manuscript is true or false, the overall argument is evaluated for its logic construction. If there is something wrong with the argument's logic construction, then the manuscript is assigned a probability value of 0 and the analysis is exited. As an example, the argument logic “(if A, then B) AND (if B, then C), then (if A, then D)” is false, as the final statement on the implication of D from A does not follow from the preceding argument. If the overall argument logic is correct however, then the analysis process proceeds to the second step.

(Step 2) In the second step, each logical statement is assigned a probability value based on the statistical results of the data that the logical statement was produced from. This probability value may be set equal to either the true negative probability, i.e. 1 minus the alpha probability, or to the true positive probability, i.e. 1 minus the beta probability, or to the product of both the true negative and true positive probabilities. In the case that either the true negative or true positive probabilities are not given in the manuscript, then estimates of their values may be calculated or simulated based on information available in the manuscript. Once each logical statement in the overall argument has an assigned probability value, then the probability values for all the statements are multiplied to calculate the probability that all are true simultaneously. The process then proceeds to the third step.

(Step 3) The third step is an assessment of all the methodologies used in the research manuscript to generate the data. If there is a problem with an experiment's methodology then the results of that particular experiment are assumed to be false and any logic statements associated with that experiment are given a probability score of 0. Using the updated logic statement probability scores, the probability of the overall logical argument is recalculated. Then the process proceeds to the fourth step.

(Step 4) In the fourth step the research manuscript is inspected for duplicated figures or text, either in the manuscript itself or plagiarized from other research manuscripts. If any duplicated text or images are found, then the overall logical argument is multiplied by the probability of 0, otherwise the argument is multiplied by a probability value of 1.

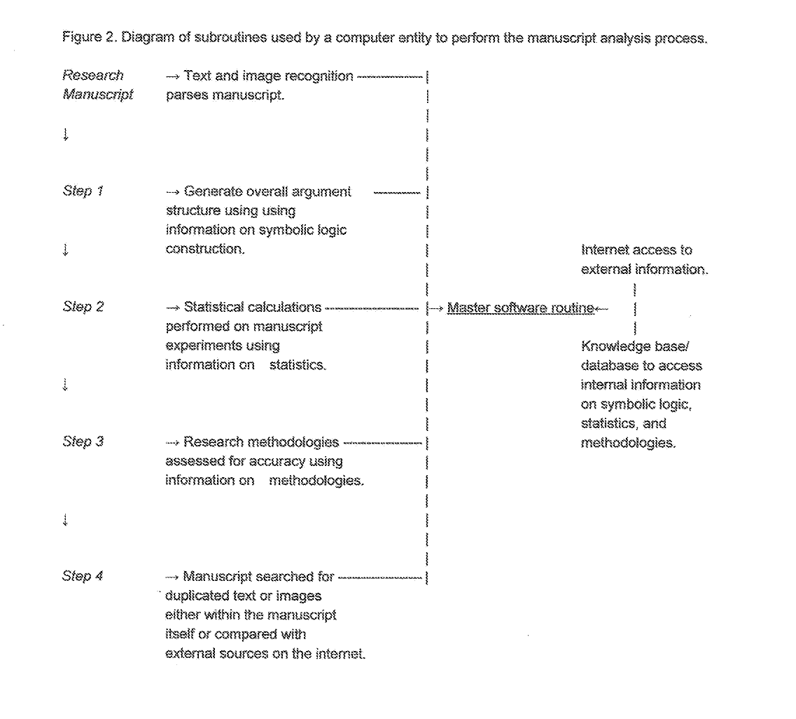

Finally, with respect to the entity that would carry out the research manuscript analysis process described in steps 1 to 4, each component of the analysis process may be carried out by a human and/or a computer. In the case of a human, the human's knowledge and/or access to information resources is used to perform the analysis. In the case of a computer, the computer would be capable of text and/or image recognition, and it would also contain or have access to a knowledge base containing information regarding symbolic logic, statistics, and relevant research methodologies. The computer also may have access to the internet or other electronic database to find relevant information to perform the analysis process described in steps 1 through 4. The subroutines used by a computer to perform each step in the analysis process is depicted in FIG. 2.

1. A standardized process to quantify the value of published research manuscripts by assigning the a single probability value that is calculated by completing the following four steps:
(Step 1) The overall argument structure of the paper is encoded into a language of symbolic logic consisting of logical statements and evaluated for its logical validity; if invalid then the manuscript is assigned a probability value of 0 and analysis is exited, otherwise analysis proceeds to Step 2;
(Step 2) each logical statement is assigned a probability value equal to the true negative probability, the true positive probability, or the product of the two, based on information provided in the manuscript about that particular logical statement, and a probability value for the entire argument is calculated by taking the product of the probability values of all the logical statements in the argument, and analysis proceeds to Step 3;
(Step 3) All the research methodologies used in the research manuscript are evaluated, and the logical statements based on incorrect methodologies are given a probability value of 0, the probability value for the entire argument is recalculated, and analysis proceeds to Step 4;
(Step 4) The research manuscript is inspected for any duplicate text or images, and if any are found then the probability value for the entire argument is multiplied by 0, otherwise the probability value for the entire argument is multiplied by 1. The analysis is then complete after Step 4.

2. A computer or computer program capable of performing the process described in claim 1 via implementation of text and/or image recognition;

3. The computer or computer program of claim 2 with the additional feature of accessing a hierarchical knowledge base database, conventional electronic database, and/or the internet, to access and utilize information on symbolic logic, statistics, and/or research methodologies.
